(19) United States
(12) Patent Application Publication
(10) Pub. No.: US 2022/0232350 A1
(43) Pub. Date: Jul. 21, 2022

(54) VEHICLE CONTROL SYSTEM AND METHOD

(71) Applicant: Transportation IP Holdings, LLC, Norwalk, CT (US)

(72) Inventors: Igor Abrosimov, Germantown, MD (US); Danial Rice, Frederick, MD (US); Dae Kim, Germantown, MD (US)

(21) Appl. No.: 17/716,715

(22) Filed: Apr. 8, 2022

Related U.S. Application Data
(63) Continuation-in-part of application No. 16/233,623, filed on Dec. 27, 2018, now abandoned.

(51) Int. Cl. H04W 4/029; H04W 4/46; H04W 4/48

(52) U.S. Cl. CPC H04W 4/029; H04W 4/48; H04W 4/46

(57) ABSTRACT

A vehicle control system includes one or more of a HOV unit or an EOV unit. The HOV unit and/or the EOV unit may include functional devices, one or more processors, and a location signal receiver. The functional devices may perform one or more operations to control operation of a vehicle system on which the HOV unit and/or the EOV unit is disposed. The location signal receiver may receive location signals from an off-board source. The one or more processors may obtain or determine a location of the HOV unit and/or the EOV unit based on the location signals and to change a mode of operation of at least one of the functional devices responsive to the location changing from a first designated area or location to a different, second designated area or location.

### CROSS-REFERENCE TO RELATED APPLICATIONS

This application is a continuation-in-part of U.S. patent application Ser. No. 16/233,623 (filed 27 Dec. 2018), the entirety of which is incorporated herein by reference.

### BACKGROUND

### Technical Field

The subject matter described herein relates to controlling (e.g., changing) operation of one or more functional modules or devices associated with a vehicle system based on a location and/or time.

Discussion of Art.

Some known functional modules or devices onboard vehicle systems are limited to a single operating mode, or to only an activated operating mode and a deactivated operating mode. For example, some known end-of-train units (EOTUs) may be limited to a single configuration profile or mode of operation that is defined for an entire cycle of operation. It is only between cycles of operation (e.g., between trips of the vehicle system) that a new configuration profile may be uploaded to or programmed in the EOTU for a subsequent cycle of vehicle operation. A cycle of operation can include travel of the vehicle system between a starting location and a destination location, with or without stops along the way between the starting location and the destination location.

One drawback to a vehicle device operating in a single mode for the entire cycle of operation is that one or more conditions during travel may change. This can result in different aspects, features, or parameters of the mode of operation not benefitting from a change in the mode of operation.

It may be desirable to have a system and method that differs from those that are currently available.

### BRIEF DESCRIPTION

In one example, a vehicle control system includes one or more of a HOV unit or an EOV unit. The HOV unit and/or the EOV unit may include functional devices, one or more processors, and a location signal receiver. The functional devices may perform one or more operations to control operation of a vehicle system on which the HOV unit and/or the EOV unit is disposed. The location signal receiver may receive location signals from an off-board source. The one or more processors may obtain or determine a location of the HOV unit and/or the EOV unit based on the location signals and to change a mode of operation of at least one of the functional devices responsive to the location changing from a first designated area or location to a different, second designated area or location.

In another example, a vehicle control system includes one or more of a HOV unit or an EOV unit that may include one or more communication devices and one or more processors. The one or more processors may obtain or determine a location of the HOV unit and/or the EOV unit and may change a mode of operation of the one or more communication devices responsive to the location changing from a first designated area or location to a second designated area or location that differs from the first designated area or location.

In another example, a method includes receiving location signals from an off-board source at a vehicle system, obtaining or determining a location of the one or more of a HOV unit or an EOV unit of the vehicle system based on the location signals, and changing a mode of operation of a functional device of the vehicle system responsive to the location changing from a first designated area or location to a second designated area or location that differs from the first designated area or location.

### BRIEF DESCRIPTION OF THE DRAWINGS

The subject matter may be understood from reading the following description of non-limiting embodiments, with reference to the attached drawings, wherein below:

FIG. 1 illustrates one example of a vehicle control system operating on a vehicle system;

FIG. 2 illustrates one example of a head of vehicle (HOV) unit and an end of vehicle (EOV) unit shown in FIG. 1;

FIG. 3 illustrates a flowchart of one example of a method of controlling operation of the EOV unit during travel of the vehicle system;

FIG. 4 illustrates one example of a method of controlling the HOV unit and/or EOV unit; and

FIG. 5 illustrates another method of controlling operation of the HOV unit and/or EOV unit during travel of the vehicle system.

### DETAILED DESCRIPTION

The subject matter described herein relates to vehicle control systems and methods of selecting modes of operation of a functional module or device associated with operation of a vehicle system based on locations and/or times. In one embodiment, the systems and methods can control (e.g., change) a mode of operation of an EOTU based on positions (or locations, such as geographic locations) of a vehicle system on which the EOTU is disposed, based on positions (e.g., locations) of the EOTU, and/or times of the day. While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy). The EOTU may optionally be referred to as an EOV unit that may be disposed onboard a rail vehicle system as an EOTU or on a non-rail vehicle system as an EOV unit. Additionally, the vehicle system may have a HOV unit (e.g., a head-of-train, or HOT, unit) that may be disposed onboard a rail vehicle system (e.g., as a HOT unit) or on a non-rail vehicle system. The EOV unit can include an EOTU, the HOV unit can include a HOT unit, and a vehicle control device can include the EOV unit and/or the HOV unit.

The systems and/or methods may operate using software directing operation of a controller that includes one or more processors and a memory. The locations can be determined from location signals obtained or received by one or more receivers, such as a Global Navigation Satellite System (GNSS) receiver (e.g., a Global Positioning System, or GPS, receiver or another receiver). Alternatively, the locations may be determined based on operator input, a dead reckoning system, wireless triangulation, passage of a vehicle system by a marker at a known or designated location, etc. In an example, the receiver that receives the location signals used to determine the locations can be part of or in communication with the vehicle control device.

Optionally, the location signals can be received by the receiver that is part of or in communication with the HOV unit of the vehicle system. The HOV unit can be disposed onboard a locomotive of the rail vehicle system or another propulsion-generating vehicle of the vehicle system. The HOV unit can include one or more processors and a memory. The controller can include one or more of the processors of the HOV unit and the EOV unit coupled to one or more memories of the HOV unit and/or the EOV unit.

The location of the EOV unit can be determined from data included in the location signals received by the receiver of the HOV unit and information in a route database stored in a memory accessible to the controller. This information can be associated with or represent a section of route being traversed by the vehicle system, a length of the vehicle system, or a distance (e.g., along the curvature or path of the route) between the HOV unit and the EOV unit.

The length of the vehicle system can be determined or estimated from the number of vehicle(s) in the vehicle system. The route database can include information indicative of at least a section of route being traversed by the vehicle system. This information can include the geography, the topography, curvature, grade, and/or distances between one or more designated locations of the section of route. Using the estimated length of the vehicle system and the distance information stored in the route database, the geographical location of the EOV unit at or about the time the location data was received by the receiver that is part of or in communication with the HOV unit can be determined (with “about” the time taking into account the time to process the received location data and to calculate the geographical location of the EOV unit from the information in the route database).

The EOV unit and/or HOV unit can dynamically switch between different configuration profiles or operating modes of operation based on information in the location signals. These signals can be repeatedly received occasionally, periodically, aperiodically, on an on-demand basis, etc. Information included in the received location signals can be used with the information stored in the route database to determine whether the vehicle system and/or HOV/EOV unit is at or approaching a designated geographical location where it would be desirable to switch from at least one configuration profile or mode of operation to another profile or mode. The EOV unit and/or HOV unit can operate according to predefined sets of parameters and switch from one configuration profile or mode of operation to another based on the geographical location that is determined.

The information included in the location signals that are received can include time(s) of day. These times can be used by the EOV unit and/or HOV unit to switch from one configuration profile or mode of operation to another. The time(s) of day can be used in combination with or separate from the geographical location of the EOV unit and/or HOV unit to switch between configuration profiles or modes of operation.

The EOV unit and/or HOV unit switching between profiles or modes can be performed by the EOV unit and/or HOV unit autonomously with or without input from external systems. The EOV unit and/or HOV unit can operate in a first mode of operation, acting in similar fashion as an existing EOV unit and/or HOV unit, and can switch to a second mode of operation responsive to reaching a first designated geographical location and/or time. Thereafter, the EOV unit and/or HOV unit can switch to another mode of operation, including the first mode of operation, responsive to a second designated geographical location and/or time being reached.

In the software running on the EOV unit and/or HOV unit, a configuration profile may include a first set of parameters that includes at least one flag or bit that can be set in a first state (e.g., “0”) or a second state (e.g., “1”) to change a function of the EOV unit and/or HOV unit between different modes of operation.

The different operating modes of the EOV unit and/or HOV unit can change which functional devices are used and/or how the functional device(s) operate in different locations and/or at different times/dates. Examples of the HOV and/or EOV unit functions that can change or be different when operating in different modes can include data transmission rates of a communication device of the EOT unit. For example, while the EOV unit and/or vehicle system is in a first geographic area (and, therefore, in a first mode of operation), the EOV unit communicates data (e.g., wirelessly) at a faster rate or bandwidth than while the EOV unit and/or vehicle system is in a different, second geographic area (and, therefore, in a second mode of operation). As another example, the EOV unit can communicate data using a lower, first power level while the EOV unit and/or vehicle system is in one mode of operation and communicate data using a greater, second power level while in another mode of operation.

As another example, the EOV unit can use different length handshake time periods while operating in different modes. For example, the EOV unit may wait a shorter period of time for exchanging messages with another device onboard the same vehicle system or another vehicle system while operating in one mode (before identifying a communication loss or inability to communicate with the other device). The EOV unit may wait a longer period of time for exchanging the messages with the other device while operating in another mode.

As another example, a lamp of the EOV unit may change operation for different operating modes of the EOV unit. The lamp may turn on in one mode, turn off in another mode, provide a constant light in another mode, provide a flashing light in another mode, change colors of the light in different modes, etc. The EOV unit can alternate between transmitting or withholding a request to another communication device to output a command for the EOV unit to change the state of the lamp in different modes.

The EOV unit and/or HOV unit can change between when data is transmitted based on the operating mode. For example, the EOV unit and/or HOV unit can send data on a periodic basis while operating in one mode, on an aperiodic or irregular basis in another mode, on-demand in another mode, etc. The time periods between successive transmissions of data by the EOV unit may change for different operating modes.

The EOV unit and/or HOV unit can change when data is acquired or received based on the operating mode. For example, the EOV unit and/or HOV unit can receive data on a periodic basis while operating in one mode, on an aperiodic or irregular basis in another mode, on-demand in another mode, etc. The time periods between successive receipt of data by the EOV unit may change for different operating modes.

The EOV unit and/or HOV unit can alternate between transmitting and not transmitting images acquired by a camera of the EOV unit and/or HOV unit (or another camera) in different operating modes. Optionally, the controller can prevent the camera from obtaining images in one operating mode but allow the camera to obtain images in another mode. Changing whether the camera is able to acquire images and/or the EOV unit and/or HOV unit is permitted to transmit the images based on the operating mode (which is based on location) can prevent the camera from obtaining images in locations where doing so is not permitted. For example, some areas may have equipment and/or routes that are owned by another entity than the entity controlling or owning the vehicle system. It may be illegal or otherwise not permitted to obtain images of the property of other persons in certain areas (e.g., certain states or countries). The operating mode of the EOV unit and/or HOV unit can be switched to a mode that does not permit the capturing or transmitting of images while the EOV unit and/or vehicle system is located in such areas. Upon leaving such an area, the operating mode can be changed to a mode that permits the capture and transmission of images.

The EOV unit and/or HOV unit can switch between acquiring and not acquiring data from a remote data source (e.g., off-board the vehicle system) in different modes. For example, in some locations, off-board data sources such as wayside sensors, other EOV and/or HOV units, dispatch facilities, etc., may be wirelessly communicated with. In these areas, the EOV unit and/or HOV unit can operate in a mode that permits communication. In other areas, these off-board data sources may not be present or wireless communication with the sources may be difficult or impeded. The EOV unit can switch to a mode that prevents communication with these sources in such areas.

The EOV unit and/or HOV unit can switch communication modes in different operating modes. A communication mode can define a type of communication that is available while operating in the associated operating mode and/or a frequency of communication (or range of frequencies) to be used while operating in the operating mode. For example, in one operating mode, the EOV unit and/or HOV unit may be restricted to using a first radio for wireless communication due to known wireless interference or wireless communication ranges within an area associated with this operating mode. In a different operating mode, the EOV unit and/or HOV unit may be restricted to using a different, second radio for wireless communication due to other known wireless interference or wireless communication ranges within another area associated with this operating mode. In yet another different operating mode, the EOV unit and/or HOV unit may be restricted to using the first and/or second radio for wireless communication due to lesser known wireless interference or longer wireless communication ranges in the area associated with this operating mode. In another operating mode, the EOV unit and/or HOV unit may be restricted to using cellular communication for wireless communication due to radio interference in the area associated with this operating mode. One or more (or another different) operating mode may restrict which frequencies are used by the communication unit of the EOV unit and/or HOV unit to a first frequency or range of frequencies, while another operating mode may restrict the communication unit to a different, second frequency or a narrower or wider second range of frequencies.

In one embodiment, the EOV unit and/or HOV unit can include at least two configuration profiles. In an example, the first configuration profile (e.g., corresponding to a first state) can include a communication device of the EOV unit and/or HOV unit (e.g., a wireless radio transceiver) operating at a first output power level (e.g., two watts). The second configuration profile (e.g., corresponding to a second state) can include the communication device of the EOV unit operating at a greater, second output power level (e.g., eight watts).

One configuration profile or mode can include a first data transmission rate from the EOV unit to the HOV unit, or vice versa, while another configuration profile or mode can include a second, faster or slower, data transmission rate from the EOV unit to the HOV unit, or vice versa. In an example, the same frequency can be used with the first and second data transmission rates.

One configuration profile or mode can include a first data logging rate and/or log content of the EOV unit that is based on the received or determined location data, while another configuration profile or mode can include a second data logging rate and/or log content. Examples of the first and second log rates and/or log contents may include, for example: changing the frequency at which the logs are generated for self-diagnosis or data gathering, enabling/disabling selected logs from being created to gather data (or save disk space and/or computing power), changing the level of event logging to gather more or less data, and/or changing the location of data logging from saving internally to EOV unit to sending data out to a remote device (e.g., a back office).

Examples of one or more events that may be logged can include, for example, the EOV unit receiving a communications test message from the HOV unit and the EOV unit responding, the EOV unit receiving an emergency message from the HOV unit and the EOV unit triggering brakes of the vehicle system and responding to the HOV unit with the results (e.g., whether the brakes were engaged), the EOV unit sending a request to the HOV unit to arm an alarm or brakes (and waiting for a response from the HOV unit), the EOV unit sensing motion and sending a motion status to the HOV unit, the EOV unit sensing change in level of lumens (e.g., brightness) of an EOV unit lamp and sending a status of the lamp to the HOV unit, the EOV unit detecting a change in configuration of the EOV unit, the EOV unit detecting a low level of a battery of the EOV unit, the EOV unit detecting an operator button being actuated, the EOV unit detecting a change in the air pressure in a brake pipe and changing a mode of operation of the brakes or the EOV unit, the EOV unit detecting connection to an external power source and changing the mode of operation of the EOV unit, and the like.

The choice between which of different configuration profiles or modes that the EOV unit operates according to may be based on a geography or features of a segment of the route on which the vehicle system is travelling or about to travel (e.g., the vehicle system is heading toward and is scheduled or planning to travel). For example, if, based on the received location data, the controller determines (with reference to the route database that may include relations between (a) different route sections or locations and (b) different configuration profiles or operating modes) that the EOV unit is in or approaching an area where switching between data transmission rates, between transmission power levels, between communication devices, etc., is desired, the communication device of the EOV unit can be switched from the one data transmission rate, power level, or communication device to a different rate, power level, or communication device. This may occur, for example, where there is a known electronically noisy wireless transmission environment (such as an urban environment) or a canyon (or tunnel) where wireless communication between the EOV unit and HOV unit may be adversely impacted.

In another example, the EOV unit switching between a first configuration profile and a second configuration profile can be based on a time, date, and/or location, determined visibility conditions, and/or detecting a light sensor failure. Switching to one of these configuration profiles may cause a lamp (e.g., a high-visibility-marker, or HVM) to be turned on in response. For example, for a particular time/date and/or location of the EOV unit determined from the received location data, the controller may determine that the vehicle system is in a location at night time (e.g., on a particular calendar date) or that the vehicle system is in an area where there is limited ambient light (even during daylight hours), whereupon the EOV unit may turn on the HVM.

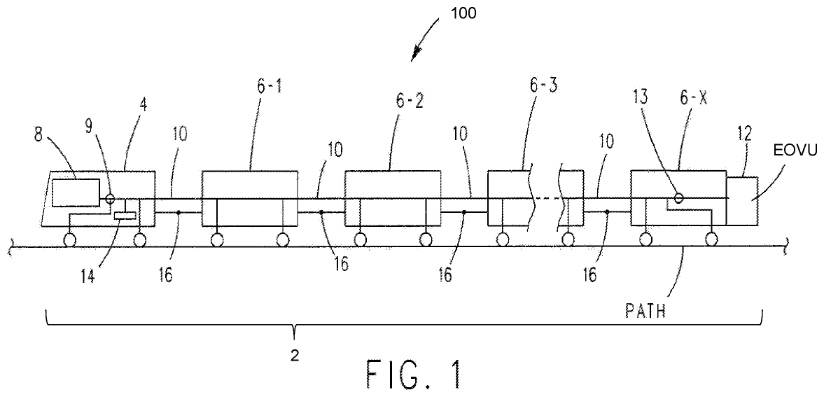

FIG. 1 illustrates one example of a vehicle control system 100 operating on a vehicle system 2. The vehicle system optionally can be referred to as a train, but also may include non-rail vehicle systems (as described herein). The vehicle system can include at least one propulsion-generating vehicle 4 such as a locomotive, automobile, agricultural vehicle, mining vehicle, or the like, that is capable of propelling itself and the vehicle system. The vehicle system optionally may include one or more non-propulsion-generating vehicles 6-1 to 6-X, where “X” can be any whole number greater than or equal to 2. These non-propulsion-generating vehicles may not be capable of self-propulsion, and may include rail cars, trailers, or the like. In the illustrated example, the vehicle system has the propulsion-generating vehicle as the lead vehicle and the non-propulsion generating vehicle 6-X is the last vehicle of vehicle system. However, the lead vehicle of the vehicle system optionally can be another propulsion-generating vehicle or a non-propulsion-generating vehicle.

The vehicle system can include a brake pipe 10 which runs the length of the vehicle system between the lead vehicle and the last or trail vehicle. In an example, the brake pipe can be pressurized with air from a compressor 14 which can be disposed in the propulsion-generating vehicle. The vehicle control system can include a HOV unit 8 disposed in the lead vehicle and an EOV unit 12 disposed in the last or trail vehicle. At least one of the functions of the HOV unit may be to control the air pressure in the brake pipe to control application of brakes of the vehicle system. The HOV unit may control the air pressure in the brake pipe 10 via a valve 9. While the valve is open, pressurized air in the brake pipe may vent to the atmosphere. In contrast, when the valve is closed, the air pressure in the brake pipe is increased by operation of the compressor. The HOV unit can be coupled to the valve to control the open and closed states thereof.

When it is desired to make a brake application, the HOV unit can cause the valve to open, thereby reducing the brake pipe air pressure. This can cause the brakes of the vehicle system to increase to a level related to the pressure of air in the brake pipe. To release the brakes, the HOV unit can cause the valve to switch to a closed state, where air generated by the compressor charges the brake pipe with pressurized air. The operation of the HOV unit to open and close the valve can be under the control of an operator via a human machine interface (not specifically disclosed herein), automatically under the control of a controller of the HOV unit (e.g., hardware circuitry that includes and/or is connected with one or more processors), or a combination thereof.

One of the drawbacks of controlling the air pressure in the brake pipe via the valve is the reaction time. For example, for long vehicle systems with, for example, 100 or more vehicles, it can take up to two minutes or more from the time the valve is set to an open state for the reduction in the air pressure in the brake pipe to propagate from the lead vehicle to the trail vehicle at the tail end of the vehicle system. This may result in two or more of the vehicles in the vehicle system applying brakes at different points in time. This may result in uneven braking and significant forces to couplers 16 that connect the vehicles of the vehicle system. To reduce this propagation delay, the EOV unit can be provided on the trail vehicle at the tail end of the vehicle system. The EOV unit can be operatively coupled to a valve 13 (which may be similar to the valve 9). Operating under the direction of the HOV unit, the EOV unit can control the open and closed states of this second valve 13 (desirably in synchronization with) the open and closed states of the first valve 9 that is controlled by the HOV unit to reduce the propagation delay in the brake pipe air pressure described above.

In another example, the HOV unit may only monitor brake pipe pressure and forward the monitored brake pipe pressure to another system, which controls the first valve.

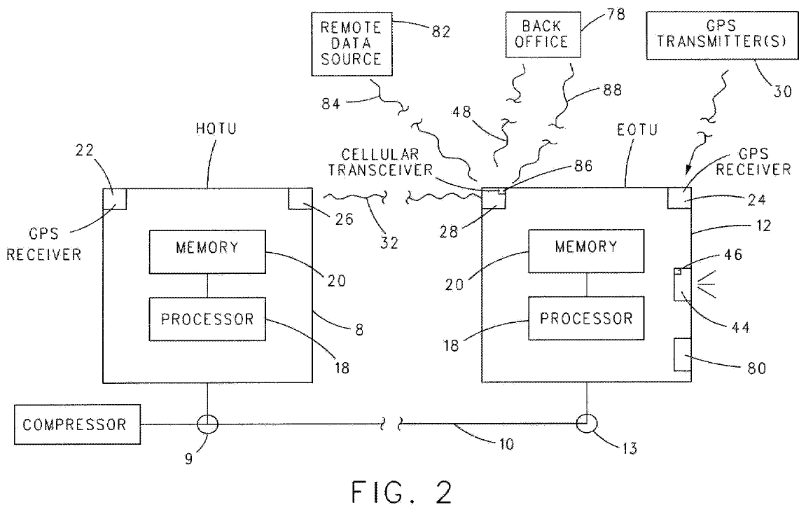

FIG. 2 illustrates one example of the HOV unit and the EOV unit 12. The HOV unit can include a one or more communication devices 26 and the EOV unit 12 can include one or more additional communication devices 28. The communication device(s) of each of the HOV unit and the EOV unit can include one or more radios, one or more cellular transceivers, or the like. The communication devices of the HOV and EOV units can be in wireless communication with each other for the wireless transfer of messages, signals, and data between the HOV unit and the EOV unit.

The HOV unit and EOV unit can each include one or more processors 18 and memories 20 coupled to processor(s) and operative for storing one or more software control programs and/or operational data. Each communication unit of the HOV and/or EOV units can be operated by a corresponding processor to pass messages, signals, and/or data between the HOV unit and the EOV unit.

The controller described herein can include one or more of the processors of the HOV unit and/or the EOV unit. When describing processing or actions performed by a controller, such processing or actions can be performed by the processor(s) of either or both the HOV unit and the EOV unit.

The EOV unit may include a location signal receiver 24. This receiver may represent a GNSS receiver, such as a GPS receiver. The location signal receiver can receive location signals which include location data from which the location signal receiver can determine a geographical location on or about the time the location signals are received by the location signal receiver. The location signals may be transmitted by one or more location signal transmitters 30 (e.g., GNSS or GPS satellites). The location signals received by the location signal receiver may include time data from which a time of day and, optionally, a current calendar date can be determined for the current location of the receiver at the geographical location.

The EOV unit may include one or more electrical/electronic devices or systems, some of which will be described hereinafter. These one or more other electrical/electronic devices or systems can be operated in different modes of operation depending on the geographical location of the EOV unit determined from location data received by the location signal receiver. Examples of changing the operational modes of the one or more electrical/electronic devices or systems of the EOV unit are described herein. The one or more electrical/electronic devices or systems having operations or modes that change based on location may include the communication unit(s).

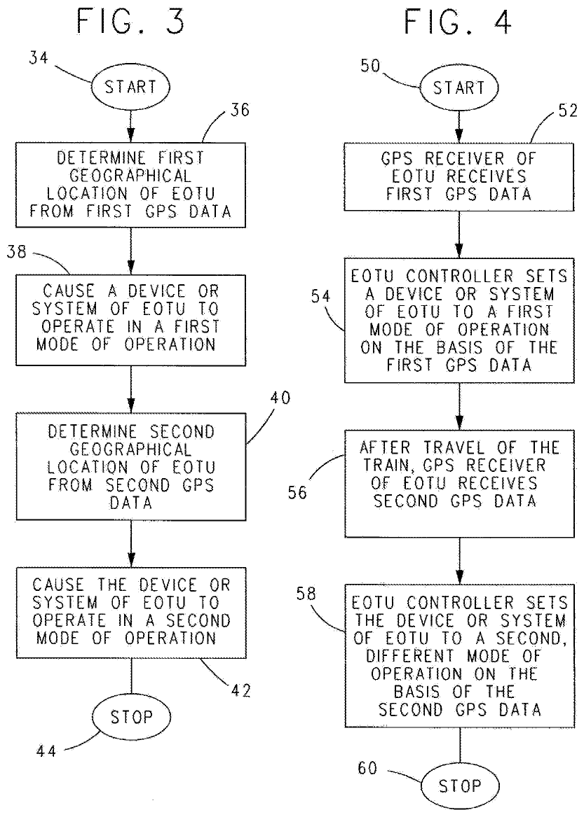

FIG. 3 illustrates a flowchart of one example of a method of controlling operation of the EOV unit during travel of the vehicle system. The method can advance from a step 34 to a step 36 where a first geographical location of the EOV unit is determined from first location data received by the location signal receiver.

At step 38, the controller of the EOV unit causes an electrical/electronic device or system of the EOV unit to operate in the first mode of operation on the basis of the first geographical location of the EOV unit that was determined at step 36.

At step 40, following travel of the vehicle system on the path (e.g., a length of a route, such as a track) after step 38, the controller can determine from second location data received by the location signal receiver, a second geographical location of the EOV unit. At step 42, the controller causes the electrical/electronic device or system of the EOV unit to operate in a second mode of operation that is different from (or different than) the first mode of operation on the basis of the second geographical location of the EOV unit that was determined at step 40. The method can then terminate at step 44 or repeat one or more prior operations of the method. For example, the steps of the method may be repeated as often as is deemed suitable and/or desirable for particular application(s) and/or environment(s). Accordingly, the description of the method including the stop step 44 is not to limit all embodiments of the subject matter described herein.

The electrical or electronic device or system (e.g., the functional device) can include the communication device of the EOV unit that can operate to communicate with the HOV unit (e.g., the communication device of the HOV unit) via a communication channel 32. This communication channel can be a wireless (radio or cellular) communication channel. Alternatively, the communication channel can be via a wired connection (e.g., a coaxial cable or other wire or cable). The communication channel may be a wired communication channel, a wireless (e.g., radio or cellular communication) channel, or a combination of a wired and wireless communication channels.

The first mode of operation can include the communication device of the EOV unit (or of the HOV unit) communicating with the communication device of the HOV unit (or of the EOV unit) at first data transmission rate. The second mode of operation can include these communication devices communicating with each other at a second, different data transmission rate. The different data transmission rates may be used (e.g., at the same carrier frequency of communication channel) where, based on the first and second geographical locations determined from the location data received by location signal receiver, it may be desirable to transmit data at a slower data transmission rate due to the potential for noise in the environment, especially where the communication channel is at least in part a wireless communication channel that can be adversely affected by such noise.

The controller can have access to a database stored in, for example, the memory of the EOV unit and/or the HOV unit. The database can include a list of geographical locations and associated desired operational states of the one or more electrical/electronic devices or systems of the EOV unit and/or HOV unit corresponding to geographical locations determined from the location data received by location signal receiver. For example, when the vehicle system is traveling on the path and enters a geographical region that includes the first geographical location, the controller can be programmed or configured to determine from the database that the electrical/electronic device or system of the EOV unit and/or the HOV unit is to operate in the first mode of operation. Moreover, as the vehicle system travels further down the path to the second geographical location, the controller can be programmed or configured to determine from the database that the electrical/electronic device or system of the EOV unit and/or the HOV unit is to operate in the second mode of operation that is different from or different than the first mode of operation.

The first geographical region may be a region that includes a noisy environment for wireless data transmission. In this example, upon the controller determining that the EOV unit and/or HOV unit is at a first geographical location within the first geographical region, the controller can direct the communication device of the EOV unit and/or HOV unit to operate in a first mode of operation that may be a slower data transmission rate that facilitates communication of data between the communication devices in such a noisy environment. Upon the controller determining that the EOV unit and/or HOV unit is at the second geographical location which is outside of the first geographical region having the noisy wireless data transmission environment (e.g., a less noisy wireless data transmission environment), the controller can direct the communication units to communicate at a second, greater data transmission rate. The same carrier frequency may be used with the first and second data transmission rates.

The first mode of operation can include the communication device of the EOV unit and/or HOV unit operating at a first transmission power level. The second mode of operation can include the communication device operating at a second, different transmission power level. In an example, a lower transmission power level (e.g., two watts) may be in an environment having less noise while a higher transmission power level (e.g., eight watts) may be in an environment having more noise.

The first mode of operation can include a first handshake period between the communication devices of the EOV unit and/or HOV unit, and the second mode of operation can include the second, different handshake period. In an example, the first handshake period may be used in environments or areas associated with increased wireless or electrical noise and may include a handshake between the communication devices every five seconds while the second handshake period may be used in environments or areas associated with decreased wireless or electrical noise and may include handshake between the communication devices every ten seconds. The handshake period may be a period of time in which signals are required to be sent and received between the communication devices. Absent a signal being sent and received within each handshake period, the controller may identify a loss or deterioration in communication between the communication units. The controller may then direct the operator to and/or may automatically slow or stop movement of the vehicle system responsive to identifying the deterioration or loss of communication between the HOV and EOV units.

The geographical regions related to the first and second geographical locations and/or the first and second geographical locations themselves can be stored in the database and used as a basis for determining when to change the operational mode of one or more of the electrical/electronic device or systems of the EOV unit and/or HOV unit. The controller can determine first and second times of day from the first and second location data. The database may include, for one or more geographical locations, a set of dates and/or times of day when it is daylight or night time in the geographical location. Each set of dates/times of day can be utilized by the controller to determine when to have an electrical/electronic device or system operating in the first mode of operation or the second mode of operation.

The electrical/electronic device or system can be a lamp 44, such as a HVM device. In an example, the lamp can be operated in the first mode of operation based on the first geographical location of the EOV unit and/or HOV unit, the first time of day, or both. The lamp can be operated in the second mode of operation based on the second geographical location of the EOV unit and/or HOV unit, the second time of day, or both. In this example, the first and second modes of operation can be the lamp being on and off, or vice versa.

The decision to operate the lamp in the first or second modes of operation can be based on the geographical location of the EOV unit and/or HOV unit. For example, while located in a tunnel, the lamp may operate in a state or mode that generates light while outside of the tunnel, the lamp may be turned off if, based on the time of day, the controller determines that it is daylight. In another example, if it is determined that the first time of day is nighttime, the lamp can be illuminated (turned on) regardless of the geographical location of EOV unit and/or HOV unit. If, based on the current geographical location of EOV unit and/or HOV unit, the controller determines that the EOV unit and/or HOV unit may be in low ambient light (e.g., in a tunnel or a canyon), the controller can direct the lamp to be turned on. In another example, if the controller determines with reference to data stored in the database for the second time of day at the current geographical location of the EOV unit and/or HOV unit that it is daylight, the lamp may be illuminated only when the geographical location of the EOV unit and/or HOV unit is determined to be one where it is desired to have the lamp illuminated (e.g., a tunnel or other location where there is limited ambient light).

The EOV unit and/or HOV unit can include a light sensor 46 for controlling the on/off state of the lamp based on ambient light received or detected by the light sensor. If the light sensor is not functioning, however, it would be desirable to control the on/off state of the lamp. The controller can determine with reference to data stored in in the database for one or more geographical locations, times of day, or both, whether there is a need to have the lamp on or off. The controller can bypass the light sensor and cause the lamp to be in the first or second mode of operation based on this reference data. For example, if the light sensor is not operational (or is providing measurements indicative of the light sensor not being operational) and the controller determines from the time of day at the current geographical location that it is night, the controller can bypass the light sensor and can cause the lamp to be in an on state. In another example, if the light sensor is not operational and the controller determines from the time of day at the current geographical location that it is daylight, the controller can bypass the light sensor and can cause the lamp to be in an off state. In another example, if, based on the geographical location the controller determines with reference to the data stored in memory that it would be desirable to have the lamp 44 in an on state regardless of the time of day (e.g., during travel in a tunnel or densely populated environment), the controller can bypass the light sensor and control the lamp to be in the on state.

The electrical/electronic device or system can comprise the combination of the controller and the communication device of the EOV unit that can be operative for communicating via the communication channel 32 with the HOV unit. In this example, the second mode of operation can comprise the controller and communication device of the EOV unit communicating a first signal (request) for the HOV unit to transmit a second signal to the EOV unit to change the state of the lamp (e.g., between off and on). The first mode of operation can include the controller and the communication device of the EOV unit not communicating (e.g., withholding) this first signal (e.g., request) to the HOV unit.

The electrical/electronic device or system can include the controller and communication device that can be operative for communicating via a communication channel 48 with an off-board system 78, such as a back office, maintenance facility, another vehicle or vehicle system, etc. The communication channel 32 between the HOV and EOV units may be referred to as an onboard channel as the units are onboard the vehicle system while the communication channel 48 can be referred to as an off-board channel as at least one of the devices, systems, or units communicating on this channel is off-board the vehicle system. The first mode of operation can comprise the controller and the communication device of the HOT unit and/or EOV unit periodically or aperiodically communicating one or more first sequential sets of vehicle system information to the off-board system via the off-board communication channel at or within a first interval of time. The second mode of operation can include the controller and communication device periodically or aperiodically communicating one or more second sequential sets of vehicle system information to the off-board system via the off-board communication channel at or within a second, different interval of time. The first interval of time may be the controller communicating with the off-board system every five minutes. The second interval of time may be the controller communicating with the off-board system every ten minutes. The first and second sequential sets of vehicle system information can be the same or different. In an example, each set of information may include, for example, one or more of communication quality, vehicle system speed determined from received location data, speed profile, an identification of the vehicle system, the current location of the HOV unit and/or EOV unit, etc. The off-board system may use some or all this information for coordinating the movement of vehicle system with other vehicle systems in a network of routes. The controller can switch the operating modes (and time intervals) based on different densities of vehicle systems and/or people in different areas. For example, in areas having more vehicle systems and/or pedestrians, the controller can switch to a shorter time interval to help keep the off-board system up to date with the vehicle system information of many vehicle systems to reduce or avoid collisions, accidents, traffic jams, etc. In areas having fewer vehicle systems and/or pedestrians, the controller can switch to a longer time interval to avoid sending too many redundant messages and overwhelming the off-board system.

The electrical/electronic device or system having the mode that changes based on location and/or time can be the controller of the HOV unit and/or EOV unit. In the first mode of operation, the controller can repeatedly acquire data from one or more vehicle devices (e.g., sensors) at or within a first interval of time. In the second mode of operation, the controller can repeatedly acquire data from the vehicle devices at or within a second different interval of time. The second interval of time can be longer than the first interval of time. In this example, the first interval of time may be, for example, five minutes and the second interval of time may be, for example, ten minutes.

Examples of such functional vehicle devices and data can include one or more of: a battery sensor (e.g., volt meter, ammeter, etc.) that measures the state of a battery of the EOV unit and/or the HOV unit, the location signal receiver, a pressure sensor that measures air pressure in the brake pipe, a valve sensor that measures a state or position of one or more of the valves, the communication devices (e.g., to measure a current data transmission rate, power level used by the communication devices, a current handshake period between the communication devices, etc.), and the like. The controller may change the time intervals over which output from the sensors is obtained or received by the controller based on location to reduce the amount of sensor output that is obtained or received while the vehicle system travels on flatter terrain and/or sections of routes having fewer curves. The sensor data may be less important for controlling operation of the vehicle system during travel in such areas when compared to traveling in areas with steeper grades (uphill and/or downhill), more curves, sharper curves, etc. (where the mode may be switched to obtain more sensor data over longer time intervals).

The electrical/electronic device or system having a mode that is switched based on location and/or date/time may comprise one or more cameras 80 of the EOV unit and/or the HOV unit. The first mode of operation can include the camera not capturing images or capturing images but not communicating the images to another of the HOV unit or EOT unit via the onboard communication channel, not communicating the images to an off-board system via the off-board communication channel, and/or not storing the images in the memory that is external to the camera. The second mode of operation can include the camera capturing images and communicating the images to another of the HOV unit or EOT unit via the onboard communication channel, communicating the images to the off-board system via the off-board communication channel, and/or storing the images in the memory that is external to the camera. The camera can be programmed, configured, or controlled to repeatedly acquire images. A first set of images acquired while the camera operates in the first mode of operation may not contain information deemed by the controller to be relevant for the purposes of data logging and may, therefore, not be transferred. On the other hand, a second set of images acquired while the camera operates in the second mode of operation may be deemed desirable to save (e.g., if the images are recording an event, such as a crash or a derailment event) and may therefore be transferred to the HOV unit and/or off-board system via the corresponding communication channel.

Capturing images of property owned or managed by another person, entity (e.g., company, partnership, corporation, etc.), or the like, may not be permitted in some jurisdictions, such as states where images may be captured where the party taking the images has some ownership interest in property that appears in the images. While traveling in these types of areas or in areas known to have no property of the owner of the vehicle system, the controller may switch the mode of operation of the camera to prevent the camera from acquiring, communicating, and/or saving images as these images may not capture property owned by the owner of the vehicle system. Upon leaving these types of areas or entering areas having property owned by the owner of the vehicle system, the controller may switch the mode of operation of the camera to allow the camera to acquire, communicate, and/or save images as the images may capture property owned by the owner of the vehicle system.

The controller may be notified (e.g., by an operator or the off-board system) of upcoming locations where an event has occurred. This event can be an accident involving another vehicle system, a location where the route was identified as potentially damaged, a location where the terrain around or beneath the route (e.g., ballast material, vegetation, etc.) may need to be examined to maintain the health of the route, a location to be inspected (e.g., to check on the status of a wayside device, to check on the status of agricultural crops growing nearby the route, etc.), or the like. Responsive to determining that the vehicle system is approaching or is within these areas, the controller can switch the mode of the camera to acquire, communicate, and/or store images. Responsive to determining that the vehicle system is no longer within these areas, the controller can switch the mode of the camera to no longer acquire, communicate, or store the images.

As another example, the controller may deactivate or activate route inspection equipment based on the mode of operation. Some areas may be associated with potentially damaged sections of a route, sections of a route that have not been inspected for at least a designated period of time, or the like. The controller can activate or deactivate the route inspection equipment based on the mode of operation that changes based on location. The route inspection equipment can include the camera described above, a system that injects electrical signals into rails to inspect the rails, an ultrasound rail inspection system, or the like.

Optionally, the controller may change the operating mode of the HOV unit and/or EOV unit to alternate between tracking fuel and/or energy usage of the vehicle system and not tracking fuel and/or energy usage of the vehicle system in different areas. For example, the controller may change the operating mode of the HOV unit and/or EOV unit while traveling in a first area to track how much fuel and/or electric energy is consumed by the vehicle system to propel the vehicle system, to operate auxiliary equipment of the vehicle system (e.g., equipment that does not operate to propel the vehicle system), or the like, while the vehicle system is in the first area. Responsive to the vehicle system exiting the first area and/or entering a second area, the controller may change the operating mode of the HOV unit and/or EOV unit to no longer track how much fuel and/or electric energy is consumed by the vehicle system to propel the vehicle system, to operate auxiliary equipment of the vehicle system, or the like. Switching the operating mode in this way can allow the controller to monitor fuel and/or energy consumption in different areas for trip planning, including the planning of refueling and/or recharging locations of the vehicle system during the current trip and/or future trips. The controller can track the fuel consumed based on output of a fuel gauge sensor and can track the energy consumed based on output from a battery sensor, ammeter, volt meter, or the like.

The electrical/electronic device or system having a mode that changes based on location can include a combination of the controller and the communication device. For example, the first mode of operation can include the controller and the communication device acquiring data from a remote data source 82 via a remote communication channel 84 based on the first geographical location of the EOV unit and/or HOV unit, the first time of day, or both. The second mode of operation can include not acquiring data from the remote data source via the remote communication channel based on the second geographical location of the EOV unit and/or HOV unit, the second time of day, or both. The remote communication channel can be a wireless communication channel between the communication device(s) and the remote data source (as an off-board system). The communication channels 48, 84 may be wireless communication channels, wired communication channels, or a combination of wired and wireless communication channels.

The remote data source may include a traffic automation system, dispatch system, or the like, and the data acquired by the controller from the remote data source can include data that is being passed between EOV and HOV units of one or more other vehicle systems.

The electrical/electronic device or system can include a cellular telephone transceiver 86 that is part of or operatively connected to the communication device or is the communication device of the EOV unit or HOV unit. The controller can cause the communication device to utilize cellular signals to communicate with back office 78 via a cellular communication channel 88 that can include a cellular network when direct radio communication with the off-board system via the radio signals is unavailable or impeded. The first mode of operation can include the controller communicating with the off-board system via the cellular communication channel. The second mode of operation can include the controller communicating with the off-board system using radio signals.

Optionally, the controller may change which communication device is used or available to communicate between devices onboard the same vehicle system (e.g., the HOV and EOV units), between devices onboard different vehicle systems, and/or between the vehicle system and one or more off-board systems based on the location and/or time/date that is determined. For example, the controller may switch operation of the HOV and/or EOV unit to a first mode of operation that directs the HOV and/or EOV unit to use a first radio to communicate while the vehicle system is within a first geographic area. Responsive to exiting this first area and/or entering a different, second geographic area, the controller may switch operation of the HOV and/or EOV unit to a second mode of operation that directs the HOV and/or EOV unit to use a different, second radio to communicate (and to no longer use the first radio while in this second area). Responsive to exiting this second area and/or entering a different, third geographic area, the controller may switch operation of the HOV and/or EOV unit to a third mode of operation that directs the HOV and/or EOV unit to use either the first radio or the second radio (or both) to communicate. Responsive to exiting this third area and/or entering a different, fourth geographic area, the controller may switch operation of the HOV and/or EOV unit to a fourth mode of operation that directs the HOV and/or EOV unit to use a cellular transceiver to communicate (and to no longer use the first or second radio while in this fourth area). Responsive to exiting the fourth area and/or entering a different, fifth geographic area, the controller may switch operation of the HOV and/or EOV unit to a fifth mode of operation that directs the HOV and/or EOV unit to use any radio or cellular transceiver that is available to a cellular transceiver to communicate (and to no longer use the first or second radio while in this fourth area).

Optionally, the controller may change which frequency and/or frequency band (e.g., range of frequencies) is used or available to the communication device for communication between devices onboard the same vehicle system (e.g., the HOV and EOV units), between devices onboard different vehicle systems, and/or between the vehicle system and one or more off-board systems based on the location and/or time/date that is determined. For example, the controller may switch operation of the HOV and/or EOV unit to a first mode of operation that directs the HOV and/or EOV unit to use a first frequency or frequency band to communicate while the vehicle system is within a first geographic area. Responsive to exiting this first area and/or entering a different, second geographic area, the controller may switch operation of the HOV and/or EOV unit to a second mode of operation that directs the HOV and/or EOV unit to use a different, second frequency or frequency band to communicate (and to no longer use the first frequency or frequency band while in this second area). Responsive to exiting this second area and/or entering a different, third geographic area, the controller may switch operation of the HOV and/or EOV unit to a third mode of operation that directs the HOV and/or EOV unit to use any frequency or frequency band that is available to communicate. Switching which communication device and/or frequency (or frequency band) is used to communicate in different areas can ensure that the HOV and/or EOV units maintain the ability to communicate in different areas associated with different amounts of wireless interference, noise, etc.

Optionally, the controller may change which communication protocol is used or available for the communication device to communicate based on the location and/or time/date that is determined. For example, the controller may switch operation of the HOV and/or EOV unit to a first mode of operation that directs the HOV and/or EOV unit to communicate using a first communication protocol while the vehicle system is within a first geographic area. Responsive to exiting this first area and/or entering a different, second geographic area, the controller may switch operation of the HOV and/or EOV unit to a second mode of operation that directs the HOV and/or EOV unit to use a different, second communication protocol to communicate (and to no longer use the first communication protocol while in this second area). Responsive to exiting this second area and/or entering a different, third geographic area, the controller may switch operation of the HOV and/or EOV unit to a third mode of operation that directs the HOV and/or EOV unit to use either the first or second communication protocols to communicate. Switching the communication protocols used by the communication device(s) based on location and/or time/date can allow the EOV unit and/or HOV unit to switch between (a) private or proprietary protocol(s) used in some areas where other devices can use the private or proprietary protocol(s) and (b) public or nonproprietary protocol(s) used in other areas where the other devices cannot or do not use the proprietary protocol(s).

In another example, the operating mode of the HOV unit and/or EOV unit can change by directing at least one of these units to communicate a signal upon entering or exiting a designated area or location. For example, the designated location can be an intersection between routes (e.g., between roads, between a track and a road, etc.), a switch at the intersection, etc. Responsive to the controller of the EOV unit or HOV unit determining that the EOV unit has passed through and is no longer in the intersection or switch (e.g., the last vehicle of the vehicle system has exited the intersection or switch, the EOV unit and/or HOV unit can be directed to communicate a signal. This signal can be communicated to other vehicle systems, to signals, to gates, etc. to notify the vehicle systems that the vehicle systems can pass through the intersection or switch, to notify a switch controller to change a state of the switch, to direct a signal at the intersection to change (e.g., to change the color of generated light, to start or stop generating light, etc.), to direct a gate controller to raise a gate at the intersection, etc. Optionally, the controller can direct the HOV unit and/or EOV unit to send a signal (e.g., a different signal) while the vehicle system is in or entering the designated location or area. For example, responsive to the controller of the EOV unit or HOV unit determining that the EOV unit has not passed through the intersection (e.g., the vehicle system is still in or passing through the intersection or switch), the EOV unit and/or HOV unit can be directed to communicate a signal. This signal can be communicated to other vehicle systems, to signals, to gates, etc. to notify the vehicle systems that the vehicle systems cannot pass through the intersection or switch, to notify a switch controller to refrain from changing a state of the switch, to direct a signal at the intersection to change (e.g., to change the color of generated light, to start or stop generating light, etc.), to direct a gate controller to keep a gate at the intersection lowered, etc.

FIG. 4 illustrates one example of a method of controlling the HOV unit and/or EOV unit. The method can advance from a start step 50 to step 52 where the location signal receiver receives first location data. The method can then advance to step 54 where a controller of the HOV and/or EOV unit can set a device or system of the unit to a first mode of operation on the basis of the first location data. In step 56, after travel of the vehicle system on the path following step 54, the location signal receiver can receive second location data. In step 58, the controller, based on the second location data, can set the device or system of the HOV and/or EOV unit to a second mode of operation. The method can then advance to stop at step 60 or return to another step. The steps of the method may be repeated as often as is deemed suitable and/or desirable for particular application(s) and/or environment(s).

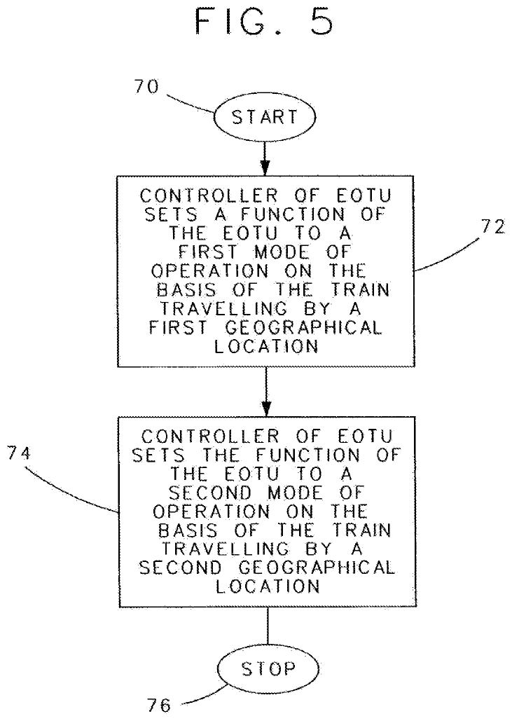

FIG. 5 illustrates another method of controlling operation of the HOV unit and/or EOV unit during travel of the vehicle system. The method can advance from start step 70 to step 72 where the controller sets a function of the HOV unit and/or EOV unit to a first mode of operation in response to a first signal received by the HOV unit and/or EOV unit on the basis of the vehicle system traveling by a first geographical location. In step 74, the controller sets the function of the HOV unit and/or EOV unit to a second, different mode of operation in the response to a second signal received by the HOV unit and/or EOV unit indicating the vehicle system has traveled by or to a second geographical location. The method can then advance to a stop step 76 or return to another step. The steps of the method of FIG. 5 may be repeated as often as is deemed suitable and/or desirable for particular application(s) and/or environment(s).

When the location signal is received by the location signal receiver of the HOV unit, the location data contained therein can be communicated to the EOV unit via the communication devices. Based on this communicated location data, the controller of the EOV unit can determine the location of the HOV unit. The controller may determine or obtain (e.g., from operator input, from data stored in the memory, etc.) the length of the vehicle system and/or the distance between the HOV unit and the EOV unit along the contour of the route over which the vehicle system is moving (e.g., the curves, grades, etc.) based on a route database stored in the memory. Based on this information, the controller can calculate or estimate the location of the EOV unit.

The HOV unit may directly command the EOV unit, via the communication devices, to set the function of the EOV unit to a different mode of operation based on data received by the location signal receiver of the HOV unit and without communicating the received location data to the EOV unit.

Various examples of the different operating modes that the HOV unit and/or EOV unit can switch between based on locations and/or times/dates are described herein. While these are described as separate or different examples, in at least one embodiment of the inventive subject matter described herein, the systems and methods can switch modes of the HOV unit and/or EOV unit by changing a combination of two or more examples described herein. For example, the change in operating mode can change two or more (or all) of the communication devices available for use, the frequency or frequency band that is used or available, the operation of a lamp, the data transmission rate, the ability of a camera to obtain and/or communicate images, the power output levels of the communication devices, the data logging rates, the activation or deactivation of fuel or energy monitoring, the activation or deactivation of route inspection equipment, the sending of signals responsive to entering or leaving a designated area or location, and the like.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

In one example, a vehicle control system includes one or more of a HOV unit or an EOV unit. The HOV unit and/or the EOV unit may include functional devices, one or more processors, and a location signal receiver. The functional devices may perform one or more operations to control operation of a vehicle system on which the HOV unit and/or the EOV unit is disposed. The location signal receiver may receive location signals from an off-board source. The one or more processors may obtain or determine a location of the HOV unit and/or the EOV unit based on the location signals and to change a mode of operation of at least one of the functional devices responsive to the location changing from a first designated area or location to a different, second designated area or location.

The functional devices may include one or more communication devices. The one or more processors may change the mode of operation of the one or more communication devices responsive to the location of the HOV unit and/or the EOV unit changing from the first designated area or location to the second designated area or location. The one or more communication devices may include first and second communication devices, and the one or more processors may change the mode of operation by preventing the first communication device from being used to communicate while the location of the HOV unit and/or the EOV unit is in the first designated area or location and preventing the second communication device from being used to communicate while the location of the HOV unit and/or the EOV unit is in the second designated area or location. The first communication device may be a radio communication device, and the second communication device may be a cellular communication device. The one or more processors may change the mode of operation of the one or more communication devices by changing which frequencies are used by the one or more communication devices.

The one or more processors may change the mode of operation of the at least one of the functional devices to monitor fuel usage and/or energy usage of the vehicle system responsive to the location of the HOV unit and/or the EOV unit being at or within the first designated area or location. The one or more processors may change the mode of operation of the at least one of the functional devices to stop monitoring the fuel usage and/or energy usage of the vehicle system responsive to the location of the HOV unit and/or the EOV unit being at or within the second designated area or location.

The one or more processors may change the mode of operation of the at least one of the functional devices to inspect a route being traveled upon by the vehicle system responsive to the location of the HOV unit and/or the EOV unit being at or within the first designated area or location. The one or more processors may change the mode of operation of the at least one of the functional devices to stop inspection of the route responsive to the location of the HOV unit and/or the EOV unit being at or within the second designated area or location. The one or more processors may change the mode of operation of the at least one of the functional devices to send a signal responsive to the location of the HOV unit and/or the EOV unit exiting the first designated area or location.

In another example, a vehicle control system includes one or more of a HOV unit or an EOV unit that may include one or more communication devices and one or more processors. The one or more processors may obtain or determine a location of the HOV unit and/or the EOV unit and may change a mode of operation of the one or more communication devices responsive to the location changing from a first designated area or location to a second designated area or location that differs from the first designated area or location.

The one or more communication devices include first and second communication devices, and the one or more processors may change the mode of operation by preventing the first communication device from being used to communicate while the location is in the first designated area or location and preventing the second communication device from being used to communicate while the location is in the second designated area or location. The first communication device may be a radio communication device, and the second communication device may be a cellular communication device. The one or more processors may change the mode of operation of the one or more communication devices by changing which frequencies are used by the one or more communication devices. The one or more processors may change the mode of operation of a functional device of the HOV unit or the EOV unit based on the location.

The one or more processors may change the mode of operation of the functional device to monitor one or more of fuel usage or energy usage of the vehicle system responsive to the location being at or within the first designated area or location. The one or more processors may change the mode of operation of the functional device to stop monitoring the fuel usage and/or energy usage of the vehicle system responsive to the location being at or within the second designated area or location. The one or more processors may change the mode of operation of the functional device to inspect a route being traveled upon by the vehicle system responsive to the location being at or within the first designated area or location. The one or more processors may change the mode of operation of the functional device to stop inspection of the route responsive to the location of the HOV unit and/or the EOV unit being at or within the second designated area or location. The one or more processors may change the mode of operation of the one or more communication devices by directing the one or more communication devices to send a signal responsive to the location exiting the first designated area or location.

In another example, a method includes receiving location signals from an off-board source at a vehicle system, obtaining or determining a location of the one or more of a HOV unit or an EOV unit of the vehicle system based on the location signals, and changing a mode of operation of a functional device of the vehicle system responsive to the location changing from a first designated area or location to a second designated area or location that differs from the first designated area or location.

The functional device may include one or more communication devices, and the mode of operation of the one or more communication devices may be changed responsive to the location changing from the first designated area or location to the second designated area or location. The one or more communication devices may include first and second communication devices, and the mode of operation may be changed by preventing the first communication device from being used to communicate while the location is in the first designated area or location and preventing the second communication device from being used to communicate while the location is in the second designated area or location. The first communication device may be a radio communication device, and the second communication device may be a cellular communication device.

In one embodiment, the controller may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., a location or change in location), use a model that associates locations with different operating modes to select an operating mode of the one or more functional devices of the HOV unit and/or EOV unit, and then provide an output (e.g., the operating mode selected using the model). The controller may receive additional input of the change in operating mode that was selected, such as analysis of noise or interference in communication signals (or a lack thereof), operator input, or the like, that indicates whether the machine-selected operating mode provided a desirable outcome or not. Based on this additional input, the controller can change the model, such as by changing which operating mode would be selected when a similar or identical location or change in location is received the next time or iteration. The controller can then use the changed or updated model again to select an operating mode, receive feedback on the selected operating mode, change or update the model again, etc., in additional iterations to repeatedly improve or change the model using artificial intelligence or machine learning.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following clauses, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended claims, along with the full scope of equivalents to which such clauses are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

A reference herein to a patent document or any other matter identified as prior art, is not to be taken as an admission that the document or other matter was known or that the information it contains was part of the common general knowledge as at the priority date of any of the claims.

What is claimed is:

1. A vehicle control system comprising:
one or more of a head of vehicle (HOV) unit or an end of vehicle (EOV) unit, the one or more of the HOV unit or the EOV unit including functional devices, one or more processors, and a location signal receiver,
the functional devices configured to perform one or more operations to control operation of a vehicle system on which the one or more of the HOV unit or the EOV unit is disposed,
the location signal receiver configured to receive location signals from an off-board source,
the one or more processors configured to obtain or determine a location of the one or more of the HOV unit or the EOV unit based on the location signals and to change a mode of operation of at least one of the functional devices responsive to the location of the one or more of the HOV unit or the EOV unit changing from a first designated area or location to a second designated area or location that differs from the first designated area or location.

2. The vehicle control system of claim 1, wherein the functional devices include one or more communication devices, and the one or more processors are configured to change the mode of operation of the one or more communication devices responsive to the location of the one or more of the HOV unit or the EOV unit changing from the first designated area or location to the second designated area or location.

3. The vehicle control system of claim 2, wherein the one or more communication devices include first and second communication devices, and the one or more processors are configured to change the mode of operation by preventing the first communication device from being used to communicate while the location of the one or more of the HOV unit or the EOV unit is in the first designated area or location and preventing the second communication device from being used to communicate while the location of the one or more of the HOV unit or the EOV unit is in the second designated area or location.

4. The vehicle control system of claim 3, wherein the first communication device is a radio communication device, and the second communication device is a cellular communication device.

5. The vehicle control system of claim 2, wherein the one or more processors are configured to change the mode of operation of the one or more communication devices by changing which frequencies are used by the one or more communication devices.

6. The vehicle control system of claim 1, wherein the one or more processors are configured to change the mode of operation of the at least one of the functional devices to monitor one or more of fuel usage or energy usage of the vehicle system responsive to the location of the one or more of the HOV unit or the EOV unit being at or within the first designated area or location,
the one or more processors are configured to change the mode of operation of the at least one of the functional devices to stop monitoring the one or more of fuel usage or energy usage of the vehicle system responsive to the location of the one or more of the HOV unit or the EOV unit being at or within the second designated area or location.

7. The vehicle control system of claim 1, wherein the one or more processors are configured to change the mode of operation of the at least one of the functional devices to inspect a route being traveled upon by the vehicle system responsive to the location of the one or more of the HOV unit or the EOV unit being at or within the first designated area or location,
the one or more processors are configured to change the mode of operation of the at least one of the functional devices to stop inspection of the route responsive to the location of the one or more of the HOV unit or the EOV unit being at or within the second designated area or location.

8. The vehicle control system of claim 1, wherein the one or more processors are configured to change the mode of operation of the at least one of the functional devices to send a signal responsive to the location of the one or more of the HOV unit or the EOV unit exiting the first designated area or location.

9. A vehicle control system comprising:
one or more of a head of vehicle (HOV) unit or an end of vehicle (EOV) unit, the one or more of the HOV unit or the EOV unit including one or more communication devices and one or more processors,
the one or more processors configured to obtain or determine a location of the one or more of the HOV unit or the EOV unit and to change a mode of operation of the one or more communication devices responsive to the location of the one or more of the HOV unit or the EOV unit changing from a first designated area or location to a second designated area or location that differs from the first designated area or location.

10. The vehicle control system of claim 9, wherein the one or more communication devices include first and second communication devices, and the one or more processors are configured to change the mode of operation by preventing the first communication device from being used to communicate while the location of the one or more of the HOV unit or the EOV unit is in the first designated area or location and preventing the second communication device from being used to communicate while the location of the one or more of the HOV unit or the EOV unit is in the second designated area or location.

11. The vehicle control system of claim 10, wherein the first communication device is a radio communication device, and the second communication device is a cellular communication device.

12. The vehicle control system of claim 9, wherein the one or more processors are configured to change the mode of operation of the one or more communication devices by changing which frequencies are used by the one or more communication devices.

13. The vehicle control system of claim 9, wherein the one or more processors also are configured to change the mode of operation of a functional device of the HOV unit or the EOV unit based on the location.

14. The vehicle control system of claim 13, wherein the one or more processors are configured to change the mode of operation of the functional device to monitor one or more of fuel usage or energy usage of the vehicle system responsive to the location of the one or more of the HOV unit or the EOV unit being at or within the first designated area or location,
the one or more processors are configured to change the mode of operation of the functional device to stop monitoring the one or more of fuel usage or energy usage of the vehicle system responsive to the location of the one or more of the HOV unit or the EOV unit being at or within the second designated area or location.

15. The vehicle control system of claim 13, wherein the one or more processors are configured to change the mode of operation of the functional device to inspect a route being traveled upon by the vehicle system responsive to the location of the one or more of the HOV unit or the EOV unit being at or within the first designated area or location,
the one or more processors are configured to change the mode of operation of the functional device to stop inspection of the route responsive to the location of the one or more of the HOV unit or the EOV unit being at or within the second designated area or location.

16. The vehicle control system of claim 9, wherein the one or more processors are configured to change the mode of operation of the one or more communication devices by directing the one or more communication devices to send a signal responsive to the location of the one or more of the HOV unit or the EOV unit exiting the first designated area or location.

17. A method comprising:
receiving location signals from an off-board source at a vehicle system;
obtaining or determining a location of the one or more of a head of vehicle (HOV) unit or an end of vehicle (EOV) unit of the vehicle system based on the location signals; and
changing a mode of operation of a functional device of the vehicle system responsive to the location of the one or more of the HOV unit or the EOV unit changing from a first designated area or location to a second designated area or location that differs from the first designated area or location.

18. The method of claim 17, wherein the functional device includes one or more communication devices, and the mode of operation of the one or more communication devices is changed responsive to the location of the one or more of the HOV unit or the EOV unit changing from the first designated area or location to the second designated area or location.

19. The method of claim 18, wherein the one or more communication devices include first and second communication devices, and the mode of operation is changed by preventing the first communication device from being used to communicate while the location of the one or more of the HOV unit or the EOV unit is in the first designated area or location and preventing the second communication device from being used to communicate while the location of the one or more of the HOV unit or the EOV unit is in the second designated area or location.

20. The method of claim 19, wherein the first communication device is a radio communication device, and the second communication device is a cellular communication device.
